(19) United States
(12) Patent Application Publication
(10) Pub. No.: US 2026/0243911 A1
(43) Pub. Date: Aug. 20, 2026

(54) METHOD FOR FULLY-AUTOMATIC FINE GEOLOGICAL DETECTION BY USING ARRAY ACOUSTIC WAVES AND APPARATUS THEREFOR CARRIED ON SHIELD MACHINE

(71) Applicant: SHANDONG UNIVERSITY, Jinan (CN)

(72) Inventors: Bin LIU, Jinan (CN); Lei CHEN, Jinan (CN); Xinji XU, Jinan (CN); Hongyi CAO, Jinan (CN); Chao FU, Jinan (CN); Zhifei GONG, Jinan (CN)

(21) Appl. No.: 19/457,309

(22) Filed: Jan. 23, 2026

Related U.S. Application Data
(63) Continuation of application No. PCT/CN2023/127954, filed on Oct. 30, 2023.

(30) Foreign Application Priority Data
Jul. 25, 2023 (CN) 2023109194181

(51) Int. Cl. G01V 1/34; E21D 9/00; G01V 1/30

(52) U.S. Cl. CPC G01V 1/345; E21D 9/003; G01V 1/303; G01V 2210/43

(57) ABSTRACT

A method for fully-automatic fine geological detection by using array acoustic waves and an apparatus therefor carried on a shield machine, including: performing array acoustic wave detection on geology in front of a cutter head by using a plurality of acoustic wave probes mounted on the cutter head, to obtain a three-dimensional (3D) image of adverse geology in front of the cutter head; wherein, mounting positions of the acoustic wave probes on the cutter head are determined by an acoustic wave probe optimization model, and the acoustic wave probe optimization model aims to minimize a peak sidelobe ratio, including a directivity function constructed according to the mounting positions of the acoustic wave probes and a peak sidelobe ratio function constructed according to the directivity function. The velocity distribution of medium ahead can be accurately obtained, realizing 3D fine imaging of adverse geology in the tunneling process of the shield machine.

### CROSS-REFERENCE TO RELATED APPLICATIONS

The present invention claims priority to Chinese Patent Application No. 202310919418.1, entitled “METHOD FOR FULLY-AUTOMATIC FINE GEOLOGICAL DETECTION BY USING ARRAY ACOUSTIC WAVES AND APPARATUS THEREFOR CARRIED ON SHIELD MACHINE”, and filed on Jul. 25, 2023, with the China National Intellectual Property Administration, which is incorporated herein by reference in its entirety and constitutes a part hereof for all purposes.

### TECHNICAL FIELD

The present invention relates to the technical field of advanced geological prediction, and particularly to a method for fully-automatic fine geological detection by using array acoustic waves and an apparatus therefor carried on a shield machine.

### BACKGROUND

The statements in this section merely provide background information related to the present invention and do not necessarily constitute the prior art.

Shield machines have become the dominant construction method for subway construction due to their safe and efficient characteristics. However, in the actual shield environment, disasters such as isolated stones, karst, and fractured zones are often encountered, causing ground instability and collapse, building collapse, and shield machine jamming, resulting in serious casualties and economic losses. Therefore, it is very necessary to accurately identify the source of disasters during the construction of shield machines. Currently, the main method is to use acoustic wave probes carried on the shield machine to perform phased array acoustic wave detection on geology to obtain a three-dimensional (3D) image of the geology. However, for existing phased array methods, such as ZL 201911338546.7, a phased array acoustic wave advanced geological detection system and method carried on a shield machine, a two-dimensional imaging result is obtained through one-dimensional linear array observation, and adverse geological information ahead is supplemented by rotation operation. The two-dimensional interpretation of the 3D result will lead to errors in the imaging result. Moreover, the imaging method uses a uniform wave velocity, which will also lead to deviations in the imaging result for the medium which is actually non-uniform, thus making it difficult to accurately and comprehensively obtain adverse geological information ahead.

In addition, the existing methods do not make the optimal selection of the mounting positions of acoustic wave probes, resulting in poor effect of the obtained 3D geological image.

### SUMMARY

In order to solve the above-mentioned problems, the present invention proposes a method for fully-automatic fine geological detection by using array acoustic waves and an apparatus therefor carried on a shield machine. By selecting mounting positions of acoustic wave probes, the acoustic wave probes are mounted as per the selected mounting positions and then perform array acoustic wave detection, and thus the velocity distribution of medium ahead can be accurately obtained, realizing 3D fine imaging of adverse geology in the tunneling process of the shield machine.

To achieve the above objective, the present invention adopts the following technical solution:

In a first aspect, a method for fully-automatic fine geological detection by using array acoustic waves carried on a shield machine is proposed, including:
performing array acoustic wave detection on geology in front of a cutter head by using a plurality of acoustic wave probes mounted on the cutter head, to obtain a 3D image of adverse geology in front of the cutter head;
wherein, mounting positions of the acoustic wave probes on the cutter head are determined by an acoustic wave probe optimization model, and the acoustic wave probe optimization model aims to minimize a peak sidelobe ratio, including a directivity function constructed according to the mounting positions of the acoustic wave probes and a peak sidelobe ratio function constructed according to the directivity function.

In a second aspect, an apparatus for fully-automatic fine geological detection by using array acoustic waves carried on a shield machine is proposed, including:
an array acoustic wave detection host, configured to encode and transmit an acoustic wave signal as well as receive an acoustic wave signal, and construct, according to the acoustic wave signal, a 3D image of adverse geology in front of a cutter head;
a plurality of acoustic wave probes mounted on the cutter head, configured to excite out the acoustic wave signals transmitted by the array acoustic wave detection host, and perform array acoustic wave detection on geology in front of the cutter head to obtain acoustic wave signals;
wherein, mounting positions of the acoustic wave probes on the cutter head are determined by an acoustic wave probe optimization model, and the acoustic wave probe optimization model aims to minimize a peak sidelobe ratio, including a directivity function constructed according to the mounting positions of the acoustic wave probes and a peak sidelobe ratio function constructed according to the directivity function.

In a third aspect, an electronic device is proposed, including a memory and a processor, as well as computer instructions stored in the memory and running on the processor, wherein when the computer instructions are run by the processor, the steps of the method for fully-automatic fine geological detection by using array acoustic waves carried on a shield machine are completed.

In a fourth aspect, a computer-readable storage medium is proposed, which is configured to store computer instructions, wherein when the computer instructions are run by a processor, the steps of the method for fully-automatic fine geological detection by using array acoustic waves carried on a shield machine are completed.

Compared with the prior art, the beneficial effects of the present invention are as follows:

1. According to the present invention, the available space for arranging the cutter head is made full use, the 3D observation in front of the shield machine can be realized through two-dimensional arrangement; the peak sidelobe ratio is used as the optimization index for the probe arrangement position, and the mounting position of the acoustic wave probe with the minimum peak sidelobe ratio is selected; after the acoustic wave probe is mounted as per this mounting position, the acoustic wave energy can be focused in front of the tunneling face, improving the detection distance and resolution of the array acoustic wave detection method.

2. The velocity distribution of medium in front of the cutter head can be obtained based on the Radon transformed reflection matrix imaging method, according to which 3D geological imaging is performed, thereby improving the imaging accuracy of adverse geology.

3. The detection time is short, meeting the demand for efficient detection ahead during the shield construction process.

The additional advantages of the present invention will be partially presented in the following description, some of which will become apparent from the following description, or learned through practice of the present invention.

### BRIEF DESCRIPTION OF THE DRAWINGS

The accompanying drawings which constitute a part of the present application provide further understanding of the present application. The schematic embodiments of the present application and description thereof are intended to explain the present application, and do not constitute an improper limitation to the present application.

FIG. 1 is a flowchart of detection according to a method disclosed in Example 1;

FIG. 2 is a diagram of arrangement of acoustic wave probes according to the method disclosed in Example 1;

FIG. 3 is a schematic diagram of an apparatus disclosed in Example 2; and

FIG. 4 is a schematic structural diagram of the apparatus disclosed in Example 2.

Reference numbers: 1. adverse geological body, 2. excited acoustic wave signal, 3. reflected acoustic wave signal, 4. cutter head, 5. acoustic wave probe, 6. shield machine, 7. central swivel joint, 8. power amplifier, 9. array acoustic wave detection host, 10. main beam, 11. roller cutter, 12. main control room.

### DETAILED DESCRIPTION

The present invention will be further described with reference to the accompanying drawings and embodiments.

It should be noted that the following detailed description is exemplary and intended to further illustrate the present application. Unless otherwise stated, all technical and scientific terms used herein have the same meanings as those commonly understood by those of ordinary skill in the art of the present application.

### Example 1

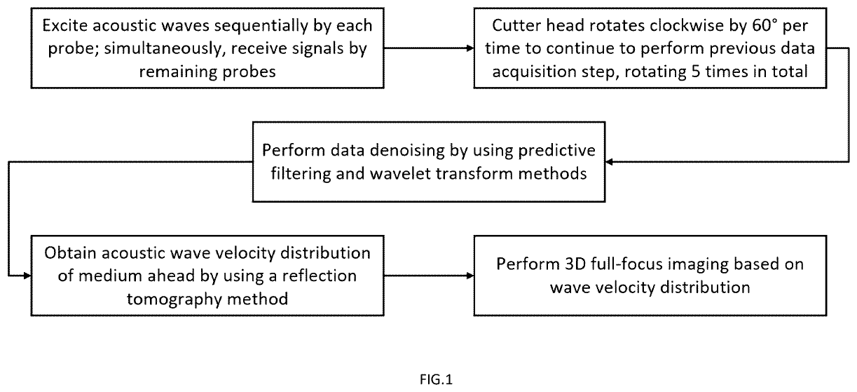

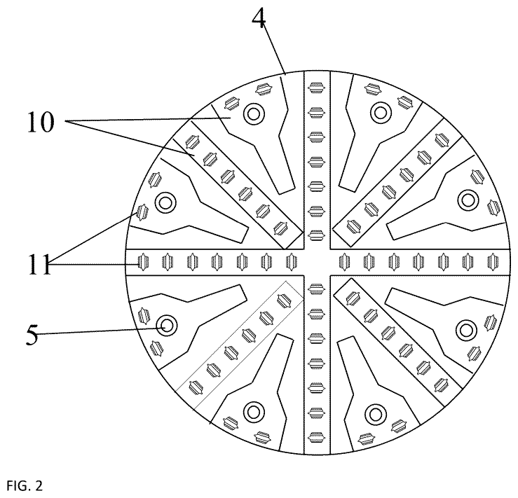

In the present example, a method for fully-automatic fine geological detection by using array acoustic waves carried on a shield machine is disclosed, as shown in FIG. 1 and FIG. 2, including:
performing array acoustic wave detection on geology in front of a cutter head by using a plurality of acoustic wave probes mounted on the cutter head, to obtain a 3D image of adverse geology in front of the cutter head;
wherein, mounting positions of the acoustic wave probes on the cutter head are determined by an acoustic wave probe optimization model, and the acoustic wave probe optimization model aims to minimize a peak sidelobe ratio, including a directivity function constructed according to the mounting positions of the acoustic wave probes and a peak sidelobe ratio function constructed according to the directivity function.

In the present example, holes are formed in a main beam 10 for mounting the acoustic wave probes 5, and the number of the mounted acoustic wave probe 5 is determined based on the actual size and structure of the cutter head 4, which is at least 6. The peak sidelobe ratio parameter is used as the optimization index of the mounting positions of the acoustic wave probes, and the mounting positions of the acoustic wave probes are determined by a nonlinear optimization method such as genetic algorithm and particle swarm algorithm.

Specifically, an acoustic wave probe optimization model is constructed and solved by a nonlinear optimization method to obtain the mounting positions of the acoustic wave probes on the cutter head, and the acoustic wave probes are mounted on the cutter head as per the mounting positions.

The acoustic wave probe optimization model aims to minimize a peak sidelobe ratio, including a directivity function constructed according to the mounting positions of the acoustic wave probes and a peak sidelobe ratio function constructed according to the directivity function.

The directivity function F(θ) is:

$$F ( θ ) = {\sum }_{i}^{N} {f}_{i} ( θ ) {e}^{{jkx}_{i} sin θ} ;$$

wherein, θ is a detection pitch angle with a value range of −90°-90°, preferably 0°; N is the number of the acoustic wave probes; fᵢ(θ) is the directivity function of each acoustic wave probe, j is imaginary unit, k is a wave number, and xᵢ is an abscissa of each acoustic wave probe, i.e. the mounting position of each acoustic wave probe, the coordinate origin being the center of the cutter head.

The peak sidelobe ratio function is:

$$P S L R = {max}_{θ ∈ S} \{ 20 lg \vert \frac{F ( θ )}{max ( F ( θ ) )} \vert \} ;$$

wherein, PLSR represents a peak sidelobe ratio parameter, the smaller the value, the more reasonable mounting position of the acoustic wave probe, and S represents a sidelobe interval of the directivity function.

With minimization of PLSR as an objective, the directivity function and the peak sidelobe ratio function are solved by the nonlinear optimization method, thereby obtaining the mounting positions of the acoustic wave probes.

The nonlinear optimization method may be a genetic algorithm, a particle swarm algorithm, etc.

After the acoustic wave probes are mounted on the cutter head as per the mounting positions, array acoustic wave detection is performed on geology in front of the cutter head to obtain a 3D image of adverse geology in front of the cutter head.

The process of performing array acoustic wave detection on geology in front of a cutter head by using a plurality of acoustic wave probes mounted on the cutter head to obtain a 3D image of adverse geology in front of the cutter head is as follows:
controlling the cutter head to rotate by a set angle each time;
when the cutter head is not rotated as well as after each rotation of the cutter head, exciting an acoustic wave signal sequentially by each of the plurality of acoustic wave probes mounted on the cutter head, while one of the probes exciting an acoustic wave signal, the remaining probes receiving the acoustic wave signal;
analyzing all the acquired acoustic wave signals through a reflection matrix method to determine velocity distribution of medium in front of the cutter head;
and obtaining the 3D image of adverse geology in front of the cutter head according to the velocity distribution of medium in front of the cutter head.

By way of example with the set angle being 60° and the cutter head being rotated for 5 times to illustrate the array acoustic wave detection process, the cutter head is controlled to rotate by 60° each time, i.e. the cutter head is rotated by 60° for the first time, and on the basis of the first rotation, the cutter head is rotated by 60° for the second time with the total rotation angle being 120°, and on the basis of the second rotation, the cutter head is rotated for the third time, and so on, until 5 times of rotation is completed.

When the cutter head is not rotated, i.e. when the cutter head is in the initial position, an acoustic wave signal is excited sequentially by each of the plurality of acoustic wave probes mounted on the cutter head for detection, and then, after each rotation of the cutter head by a set angle, an acoustic wave signal is also excited by each of the plurality of acoustic wave probes mounted on the cutter head for detection.

In the present example, under the control of an array acoustic wave detection host 9, an acoustic wave signal is excited sequentially by each of the plurality of acoustic wave probes. Simple harmonic waves and three-peak waves of different frequencies may be selected. The intensity of the excited signal is amplified by a power amplifier 8. While one of the probes excites the acoustic wave signal, the remaining probes receive reflected acoustic wave signals from adverse geology in front, and store the received acoustic wave signals in the array acoustic wave detection host.

After the cutter head is rotated for 5 times, 6 sets of acoustic wave signals are collected, which are represented by D. The data dimension of D is nrot×nsour×nrec×nt, wherein nrot=6, representing a total of 6 sets of data for rotation from 0°, 60°, 120° to 300° respectively, nsour represents the number of exciting acoustic wave probes per set of data, nrec represents the number of receiving acoustic wave probes per set of data, and nt represents the number of data sampling points.

All of the acquired acoustic wave signals D are denoised to obtain denoised acoustic wave signals. A reflection matrix method is used to analyze the denoised acoustic wave signals so as to determine velocity distribution of medium in front of the cutter head.

All of the acquired acoustic wave signals may be denoised in a manner such as predictive filtering or wavelet transform.

The process of determining velocity distribution of medium in front of the cutter head through the reflection matrix method is as follows:
performing Fourier transform on the acoustic wave signals D to obtain frequency domain data D_{f}, thereby converting the acoustic wave signals from a time domain to a frequency domain;
performing 3D mesh division on an area in front of the shield machine, an xy plane of a 3D mesh being parallel to a plane of the cutter head, and a z-direction of the 3D mesh being a tunneling direction of the shield machine;
for each depth z in front of the shield machine, calculating reflection matrices of different scanning velocities according to the frequency domain data, and with a center of the reflection matrix as a coordinate origin, performing Radon transform on the different reflection matrices to form a velocity scanning spectrum; selecting the velocity at the depth z from the velocity scanning spectrum;
and the velocities at all depths z forming the velocity distribution of medium in front of the cutter head.

The calculation method of the reflection matrix is as follows:

$$R ( J , J , z ) = {\sum }_{l = 1}^{nrot} {\sum }_{m = 1}^{nsour} {\sum }_{n = 1}^{nrec} {\sum }_{f = {f}_{min}}^{{f}_{max}} {G}_{s}^{*} ( J , z , f ) \times D ( z , f ) \times {G}_{R}^{T} ( J , z , f ) ;$$

$${G}_{S / R} ( J , z , f ) = \frac{{e}^{- j 2 π f \sqrt{{\vert J - {C}_{sour} / {C}_{rec} \vert}^{2} + {z}^{2}} / {v}_{scan}}}{4 π \sqrt{{\vert J - {C}_{sour} / {C}_{rec} \vert}^{2} + {z}^{2}}} ;$$

wherein, R(J,J,z) represents a reflection matrix at each depth z, J represents a coordinate J(x,y) of an imaging point on the xy plane at the depth z, G_{S/R}(J,z,f) can be Gₛ(J,z,f) or G_{R}(J,z,f), Gₛ(J,z,f) and G_{R}(J,z,f) represent a Green's function of the excitation acoustic wave probe end and the receiving acoustic wave probe end respectively, * represents a matrix conjugate operator, T represents a transposed conjugate operator, Cₛₒᵤᵣ and C_{rec} are coordinates Cₛₒᵤᵣ(x,y) and C_{rec}(x,y) of the excitation probe and the receiving probe respectively, v_{scan} is a scanning velocity value, and f is a frequency of an acoustic wave signal.

At each depth z, the coordinate origin is taken from the center of the reflection matrix of this depth, and Radon transform is performed on the reflection matrices at different scanning velocities v_{scan}. The Radon domain data when k=1 is taken and combined to form the velocity scanning spectrum as per different scanning velocities. The abscissa of the scanning velocity spectrum is the scanning velocity, and the ordinate is the intercept of the Radon domain.

A velocity corresponding to a point with the highest vertical resolution in the scanning velocity spectrum is selected as the velocity at depth z.

When there is a plurality of points with the highest vertical resolution in the scanning velocity spectrum, a velocity corresponding to the point with the strongest amplitude energy is selected from all the points with the highest vertical resolution as the velocity at depth z.

The velocities at all depths z form velocity distribution of medium in front of the cutter head.

After the velocity distribution of medium in front of the cutter head is obtained, a reflection matrix at each depth is calculated according to the velocity of medium in front of the cutter head; an imaging result at each depth is obtained according to the reflection matrix as a 3D image at that depth; the 3D images at all depths constitute the 3D image of adverse geology in front of the cutter head.

Specifically, the Green's function Gₛ′(J,z,f) of the excitation acoustic wave probe and the Green's function G_{R}′(J,z,f) of the receiving acoustic wave probe are calculated according to the velocity distribution of medium in front of the cutter head:

$${G}_{S / R}^{′} ( J , z , f ) = \frac{{e}^{- j 2 π ft}}{4 π \sqrt{{\vert J - {C}_{sour} / {C}_{rec} \vert}^{2} + {z}^{2}}} ;$$

$$t = \frac{{S}_{sour} + {S}_{rec}}{L} ( {\sum }_{m = 1}^{nlayer} \frac{{l}_{m}}{{v}_{m}} ) ;$$

wherein, Sₛₒᵤᵣ is the distance between an imaging point and an excitation point, S_{rec} is the distance between the imaging point and a receiving point, L is the depth of the imaging point in the z-direction, lₘ and vₘ are the thickness and velocity of each layer in the acoustic wave propagation path respectively, and nlayer is the total number of velocity layers through which the acoustic wave propagation path passes.

The reflection matrix R′(J,J,z) at each depth is calculated according to the calculated the Green's function Gₛ′(J,z,f) of the excitation acoustic wave probe and the Green's function G_{R}′(J,z,f) of the receiving acoustic wave probe.

The imaging result at each depth is obtained through a main diagonal value of the reflection matrix at each depth. That is, the main diagonal value of the reflection matrix is taken to obtain the imaging result Imag(x,y,z)=Imag(J,z)=diag(|R′(J,J,z)|) at each depth z, wherein diag represents operation of taking a diagonal value.

According to the method disclosed in the present example, the available space for arranging the cutter head is made full use, the 3D observation in front of the shield machine can be realized through two-dimensional arrangement; the peak sidelobe ratio is used as the optimization index for the probe arrangement position, and the mounting position of the acoustic wave probe with the minimum peak sidelobe ratio is selected; after the acoustic wave probe is mounted as per this mounting position, the acoustic wave energy can be focused in front of the tunneling face, improving the detection distance and resolution of the array acoustic wave detection method.

In the present example, the velocity distribution of medium in front of the cutter head can be obtained based on the Radon transformed reflection matrix imaging method, according to which 3D geological imaging is performed, thereby improving the imaging accuracy of adverse geology.

### Example 2

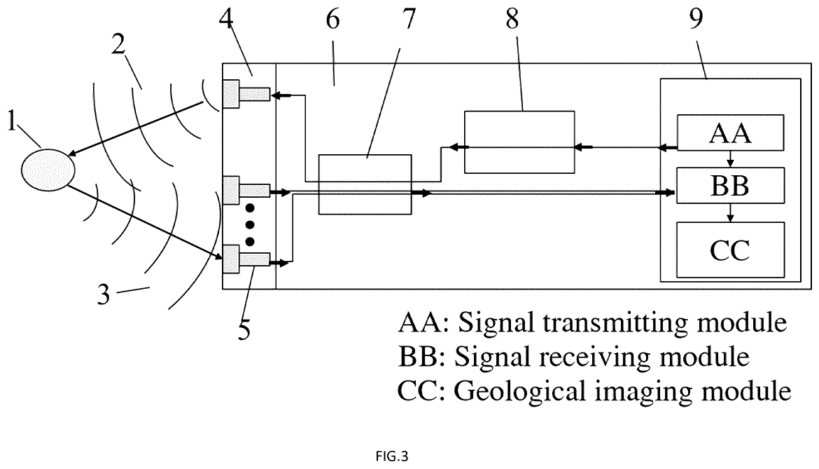

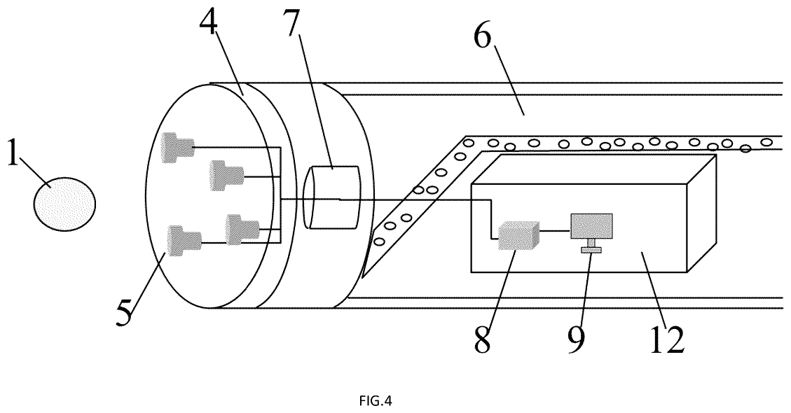

In the present example, an apparatus for fully-automatic fine geological detection by using array acoustic waves carried on a shield machine is disclosed, as shown in FIG. 3 and FIG. 4, including:
an array acoustic wave detection host 9, configured to encode and transmit an acoustic wave signal as well as receive an acoustic wave signal, and construct, according to the acoustic wave signal, a 3D image of adverse geology in front of the cutter head;
a plurality of acoustic wave probes 5 mounted on the cutter head 4, configured to excite out acoustic wave signals transmitted by the array acoustic wave detection host, and perform array acoustic wave detection on geology in front of the cutter head to obtain acoustic wave signals;
wherein, mounting positions of the acoustic wave probes on the cutter head are determined by an acoustic wave probe optimization model, and the acoustic wave probe optimization model aims to minimize a peak sidelobe ratio, including a directivity function constructed according to the mounting positions of the acoustic wave probes and a peak sidelobe ratio function constructed according to the directivity function.

Specifically, the cutter head 4 includes a roller cutter 11 and a main beam 10; 6 acoustic wave probes in total are arranged, which are mounted on the main beam 10 as per the determined mounting positions, and each of the acoustic wave probes is allowed for excitation and reception of an acoustic wave signal.

A central swivel joint 7 is arranged inside the shield machine 6, and cables such as a circuit and an oil circuit, which connect the acoustic wave probes and the array wave detection host, are accommodated by the central swivel joint 7, so as to ensure automatic control of the acoustic wave probes by the array acoustic wave detection host 9, thereby realizing signal transmission between the acoustic wave probes 5 and the array acoustic wave detection host 9.

A power amplifier 8 is further arranged between the acoustic wave probes 5 and the array acoustic wave detection host 9, and the array acoustic wave detection host 9 and the power amplifier 8 are mounted in a main control room 12 of the shield machine.

The power amplifier 8 performs energy enhancement on the acoustic wave signal encoded and transmitted by the array acoustic wave detection host 9, and then sends the energy-enhanced acoustic wave signal to the acoustic wave probe to be excited out, improving the penetration distance of acoustic waves.

The acoustic wave probe can transmit a high-frequency acoustic wave signal (the main frequency being 4 kHz) and receive a broadband acoustic wave signal of 0-200 kHz, and is automatically extendable and retractable through a hydraulic telescopic apparatus.

The array acoustic wave detection host 9 can encode and transmit an acoustic wave signal to the acoustic wave probe, store a reflected signal received by the acoustic wave probe, and process the reflected signal to realize 3D fine imaging of adverse geology ahead.

The detection process of the detection apparatus disclosed in the present example is as follows:

(1) A signal transmitting module in the array acoustic wave detection host encodes and transmits a signal, which is transmitted to the power amplifier for energy amplification, and then transmitted to the acoustic wave probe on the cutter head through the central swivel joint for excitation of the acoustic wave signal.

(2) The excited acoustic wave signal 2 propagates to an adverse geological body 1 to generate a reflected acoustic wave signal 3, which is received by another acoustic wave probe and transmitted to a receiving module of the array acoustic wave detection host for data storage.

(3) The process continues according to steps (1) and (2) to acquire acoustic wave data obtained by excitation of the remaining acoustic wave probes.

(4) The array acoustic wave detection host controls the cutter head to rotate by certain angle to continue the data acquisition operation according to steps (1) to (3).

(5) A geological imaging module of the array acoustic wave detection host performs geological imaging on the acquired acoustic wave signals.

According to the detection apparatus disclosed in the present example, the available space for arranging the cutter head is made full use, the 3D observation in front of the shield machine can be realized through two-dimensional arrangement; by using the peak sidelobe ratio as the optimization index for the probe arrangement position, the acoustic wave energy can be focused in front of the tunneling face, improving the detection distance and resolution of the array acoustic wave detection method; the velocity distribution of medium in front of the cutter head can be obtained based on the Radon transformed reflection matrix imaging method, according to which 3D geological imaging is performed, thereby improving the imaging accuracy of adverse geology; the detection time is short, meeting the demand for efficient detection ahead during the shield construction process.

### Example 3

In the present example, an electronic device is disclosed, including a memory and a processor, as well as computer instructions stored in the memory and running on the processor, wherein when the computer instructions are run by the processor, the steps of the method for fully-automatic fine geological detection by using array acoustic waves carried on a shield machine disclosed in Example 1 are completed.

### Example 4

In the present example, a computer-readable storage medium is disclosed, which is configured to store computer instructions, wherein when the computer instructions are run by a processor, the steps of the method for fully-automatic fine geological detection by using array acoustic waves carried on a shield machine disclosed in Example 1 are completed.

Finally, it should be noted that the above embodiments are only used to illustrate the technical solutions of the present invention and not to limit it. Although the present invention has been described in detail with reference to the above embodiments, those of ordinary skill in the art should understand that modifications or equivalent substitutions may still be made to the specific embodiments of the present invention without departing from the spirit and scope of the present invention, and should be covered within the protection scope of the claims of the present invention.

1. A method for fully-automatic fine geological detection by using array acoustic waves carried on a shield machine, comprising:
performing array acoustic wave detection on geology in front of a cutter head by using a plurality of acoustic wave probes mounted on the cutter head, to obtain a 3D image of adverse geology in front of the cutter head, wherein the specific process is as follows:
controlling the cutter head to rotate by a set angle each time;
when the cutter head is not rotated as well as after each rotation of the cutter head, exciting an acoustic wave signal sequentially by each of the plurality of acoustic wave probes mounted on the cutter head, while one of the probes exciting an acoustic wave signal, the remaining probes receiving the acoustic wave signal;
analyzing all the acquired acoustic wave signals through a reflection matrix method to determine velocity distribution of medium in front of the cutter head, wherein the specific process is as follows:
performing Fourier transform on the acoustic wave signals to obtain frequency domain data;
performing 3D mesh division on an area in front of the shield machine, an xy plane of a 3D mesh being parallel to a plane of the cutter head, and a z-direction of the 3D mesh being a tunneling direction of the shield machine;
for each depth in the tunneling direction of the shield machine, calculating reflection matrices of different scanning velocities according to the frequency domain data, with a center of the reflection matrix as a coordinate origin, performing Radon transform on the different reflection matrices to form a velocity scanning spectrum, and selecting the velocity at that depth from the velocity scanning spectrum;
the velocities at all depths in the tunneling direction of the shield machine forming the velocity distribution of medium in front of the cutter head; and
obtaining the 3D image of adverse geology in front of the cutter head according to the velocity distribution of medium in front of the cutter head;
wherein mounting positions of the acoustic wave probes on the cutter head are determined by an acoustic wave probe optimization model, and the acoustic wave probe optimization model aims to minimize a peak sidelobe ratio, comprising a directivity function constructed according to the mounting positions of the acoustic wave probes and a peak sidelobe ratio function constructed according to the directivity function.

2. The method for fully-automatic fine geological detection by using array acoustic waves carried on a shield machine according to claim 1, wherein the acoustic wave probe optimization model is solved by a nonlinear optimization method to obtain the mounting positions of the acoustic wave probes on the cutter head, and the acoustic wave probes are mounted on the cutter head as per the mounting positions.

3. The method for fully-automatic fine geological detection by using array acoustic waves carried on a shield machine according to claim 1, wherein a velocity corresponding to a point with the highest vertical resolution in the scanning velocity spectrum is selected as the velocity at that depth in the tunneling direction of the shield machine.

4. The method for fully-automatic fine geological detection by using array acoustic waves carried on a shield machine according to claim 1, wherein a reflection matrix at each depth is calculated according to the velocity of medium in front of the cutter head;
an imaging result at each depth is obtained according to the reflection matrix as a 3D image at that depth; and
the 3D images at all depths constitute the 3D image of adverse geology in front of the cutter head.

5. The method for fully-automatic fine geological detection by using array acoustic waves carried on a shield machine according to claim 4, wherein the imaging result at each depth is obtained through a main diagonal value of the reflection matrix at each depth.

6. An apparatus for the method for fully-automatic fine geological detection by using array acoustic waves carried on a shield machine according to claim 1, comprising:
an array acoustic wave detection host, configured to encode and transmit an acoustic wave signal as well as receive an acoustic wave signal, and construct, according to the acoustic wave signal, a 3D image of adverse geology in front of a cutter head;
a plurality of acoustic wave probes mounted on the cutter head, configured to excite out the acoustic wave signals transmitted by the array acoustic wave detection host, and perform array acoustic wave detection on geology in front of the cutter head to obtain acoustic wave signals;
wherein mounting positions of the acoustic wave probes on the cutter head are determined by an acoustic wave probe optimization model, and the acoustic wave probe optimization model aims to minimize a peak sidelobe ratio, comprising a directivity function constructed according to the mounting positions of the acoustic wave probes and a peak sidelobe ratio function constructed according to the directivity function.

7. An electronic device, comprising a memory and a processor, as well as computer instructions stored in the memory and running on the processor, wherein when the computer instructions are run by the processor, implementing the steps of the method for fully-automatic fine geological detection by using array acoustic waves carried on a shield machine according to claim 1.

8. A non-transitory computer-readable storage medium, configured to store computer instructions, wherein when the computer instructions are run by a processor, implementing the steps of the method for fully-automatic fine geological detection by using array acoustic waves carried on a shield machine according to claim 1.
